(19) United States
(12) Patent Application Publication
(10) Pub. No.: US 2024/0428355 A1
(43) Pub. Date: Dec. 26, 2024

(54) Smart Legal Contracts

(71) Applicant: David Arthur Harness, Bakersfield, CA (US)

(72) Inventor: David Arthur Harness, Bakersfield, CA (US)

(21) Appl. No.: 18/751,935

(22) Filed: Jun. 24, 2024

(51) Int. Cl. G06Q 50/18; G06Q 20/22

(52) U.S. Cl. CPC G06Q 50/186; G06Q 20/223

(57) ABSTRACT

The invention is a browser user interface generating a new class of smart legal contracts electronic documents for traditional, natural-language, legally-binding agreements; wherein invention electronic document generation includes blockchain API wallet signing of digital asset transactions generating PDF downloads with transaction hash links to the blockchain ledger network. Invention user interface is fully browserified wherein the smart legal contract tokenization, payment, trustline, hook, and escrow blockchain transactions are integral to the electronic document programming of its direct peer to peer API transactions with the blockchains, for example XRP Ledger (XRPL) transactions with Xaman API wallet signing. Hence invention features the three conditions needed to formalize the intent of binding written contracts: subject, consideration, and capacity, while incorporating blockchain safeguards against the product of forgery or perjury sought by Uniform Commercial Code. For example, the electronic documents currently active on inventor's domain smartlegalcontracts.net user interface operating on the XRPL Mainnet.

### BACKGROUND OF THE INVENTION

This invention falls within the field of electronic documents and distributed computer systems for transmitting and receiving data; wherein, as shown in FIG. 1, conventional electronic documents 1 are the basis of much of the world commercial system records of enterprise institutions banking account transactions, credit card payments 2, and their corporate ledger records 3 of various forms of escrow agreements including mortgages and other debt payment instruments. The various specific terms of which are explained and agreed to by way of initialing and signing paper and electronic documents generated and stored according to various standards 4; wherein the jurisdictional court and corporate enterprise intent exists to further develop and legally adopt on a widespread basis a Uniform Commercial Code for electronic documents.

Smart legal contracts are distinct from smart contracts. A smart contract is not necessarily legally enforceable as a contract. On the other hand, smart legal contracts, which have not taken form in the prior art, are anticipated by many to eventually embody the traditional, natural-language, legally-binding agreements in some yet to be determined manner with blockchain tokenization technology, having all the elements of a legally enforceable contract in the jurisdiction in which it can be enforced by a court or tribunal. Wherein the anticipated smart legal contracts will be legally-enforceable if they contain the three conditions needed for binding written contracts; subject, consideration, and capacity; wherein the appeal of blockchain technology is to guard against the product of forgery or perjury.

Tokenization of all enterprise assets is widely seen to be the future of enterprise electronic documentation; wherein the development of a proper user interface is widely seen to be the key feature which will drive adoption.

The invention is such a proper user interface needed for the otherwise undefined new class of smart legal contract electronic documentation of the workflow of traditional, natural-language, legally-binding agreements with blockchain wallet signing of digital asset transactions in accord with the intent of the Uniform Commercial Code of electronic documents by way of direct peer to peer blockchain transactions maximizing the desired blockchain protections against the product of forgery or perjury thus fulfilling the potential to tokenize the globally emerging fintech asset matrix.

Artificial intelligence development, such as ChatGPT for Lawyers, is proceeding rapidly one objective being to act as a rational agent in legal and financial planning decision-making taking actions to make specific goals happen.

### SUMMARY OF THE INVENTION

The invention is a new user interface for a new class of smart legal contracts electronic documentation of the intent of traditional, natural-language, legally-binding agreements; wherein the invention user interface for the traditional agreements utilizes blockchain API wallet signing of digital asset transactions generating a PDF download with transaction hash links to the blockchain ledger forming a peer to peer electronic document network in accord with the objectives of the Uniform Commercial Code of electronic documents. Invention user interface is fully browserified to execute the smart legal contract tokenization, payment, escrow, trustline, hooks, and other API blockchain transactions which are integral to the electronic document programming of its direct peer to peer html javascript-python API transactions with the blockchains, for example XRP Ledger (XRPL) transactions with Xaman API wallet signing. Hence the invention documents the intent of the three conditions needed for binding written contracts; subject, consideration, and capacity, while incorporating blockchain safeguards against the product of forgery or perjury. For example, the html javascript Xaman API XRPL electronic documents currently active on the inventor's domain smartlegalcontracts.net user interface operating on the XRPL Mainnet.

The invention smart legal contracts internet blockchain network establishes a new electronic documents standard commensurate with the anticipated Uniform Commercial Code of electronic documents while further providing a standard for AI rational agent training sets for assisting in lawyer-client formalization of court documents, in maintaining the three conditions needed for binding written contracts; subject, consideration, and capacity, while incorporating blockchain safeguards against the product of forgery or perjury.

Thus the value of the invention can be measured in terms of its holographic data compression in executing the same operation with fewer steps as a measure of human-AI machine learning in line with human-AI rational agent alignment towards achieving the corporate enterprise goal to tokenize the emerging system of global fintech assets.

### BRIEF DESCRIPTION OF THE DRAWINGS

FIG. 1 shows an illustrative diagram of the prior art enterprise electronic document 1 internet linked network where records of credit card payment, bank, and other transactions 2 and 3 are stored on enterprise backend server document storage 4 databases via various protocols to various levels of network security.

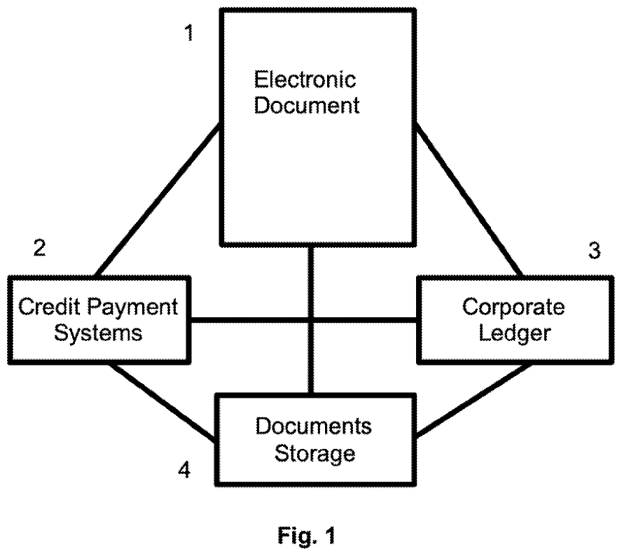

FIG. 2 shows an illustrative diagram of the smart legal contract electronic document 5 internet-blockchain linked network wherein user interface of the invention blockchain transaction protocols are encoded into the smart legal contract records of credit card payment, bank, and other signed transactions 6 and 7 with maximum level of network security for Uniform Commercial Code of electronic documents storage 8 via peer to peer sharing of trusted files and APIs.

### DETAILED DESCRIPTION OF THE INVENTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well known structures and devices are shown in block diagram form in order to avoid unnecessarily obscuring the embodiments of the invention.

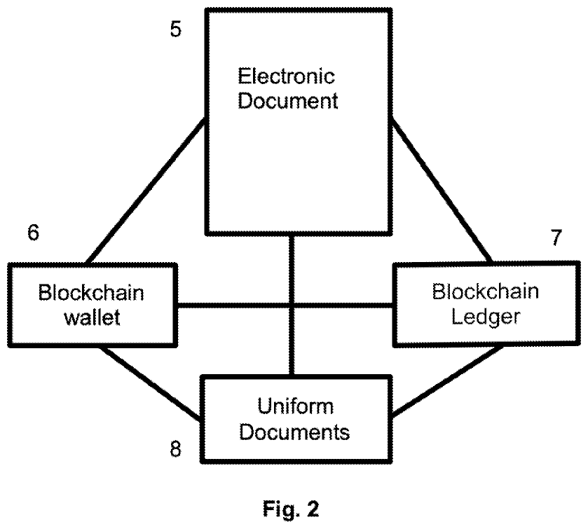

The invention user interface for its smart legal contracts electronic document network of FIG. 2 documents the intent of the workflow of traditional, natural-language, legally-binding agreements in a conventional computer browser electronic document 5 with smartphone blockchain API wallet signing 6 of digital asset transactions with a PDF download having transaction links to the blockchain 7 stored commensurate with the anticipated objectives of a Uniform Commercial Code for electronic documents 8.

Tokenization of the smart legal contract is encoded into the document minting a non fungible token (NFT) to generate the tokenized smart legal contract ID.

The Tokenization, Buyer and Seller payment transactions, and Borrower and Lender escrow transactions wallet signing javascript-python API operations are integral to the PDF electronic document encoding, which encoding is fully browserifed in that all javascript-python API tokenization, payment, escrow, trustline, hooks, and other API blockchain transactions are peer to peer interacting directly with the blockchains not requiring the maintenance and securing of a backend intermediary third parties. So that trusted html files, javascript-python, APIs, and domains form the invention new class of smart legal contract uniform electronic document PDF protocol realizes the potential to tokenize the globally emerging fintech asset matrix in the form of smart legal contract trusted networks.

For example, the inventor's domain smartlegalcontracts.net html javascript API smart legal contract electronic document transactions generating PDF downloads currently operates on the XRPL Mainnet with Xaman API wallet signing.

Thus the invention smart legal contracts have all the elements of legally enforceable contracts in the traditional jurisdictions in which they can be enforced by a court or tribunal as legally-enforceable by formalizing the intent of the three traditional conditions needed for binding written contracts; subject, consideration, and capacity; maximizing blockchain protections against the product of forgery or perjury.

Hence the value of the invention is measured in terms of holographic data compression being the execution of an equivalent operation with fewer steps as the measure of machine learning in line with human-AI rational agent alignment with human values and ethics.

1. The invention is a new user interface for a new class of smart legal contracts electronic documents which document the intent of traditional, natural-language, legally-binding agreements; wherein invention user interface for the traditional agreements utilizes blockchain API wallet signing of digital asset transactions generating PDF download with transaction hash links to the blockchain forming a peer to peer electronic document network in accord with the anticipated objectives of the Uniform Commercial Code of electronic documents. Invention user interface is fully browserified wherein the smart legal contract tokenization, payment, escrow, trustline, hooks, and other API blockchain transactions are integral to the electronic document encoding of its direct peer to peer html javascript-python API transactions with the blockchains, for example XRP Ledger (XRPL) transactions with Xaman API wallet signing.

1. The method of claim 1 further establishes a new electronic documents standard commensurate with the objectives of the anticipated Uniform Commercial Code for electronic documents; wherein all of the wallet signing API coding is integral to the programming of the document, for such as the tokenization of the smart legal contract, Bill of Sale Buyer and Seller payment signing, Security Agreement Borrower and Lender escrow signing, and Electronic wills—Self-proving document signing of Testator, Witness, and Notary cursive font signing. The PDF download format also conforms to the traditional electronic document format of record optimizing the conversion to tangible paper securing information content as expected to be required by the eventual adoption of a Uniform Commercial Code for electronic documents.

2. Invention user interface for new class of smart legal contracts electronic documents aligns with the human interaction workflow between a client, lawyer, witness, and notary officials of traditional, natural-language, legally-binding agreements and advances the prior art of electronic document formulation in that all the preliminary and intermediate blockchain wallet signing steps between a client, lawyer, witness, and notary officials are also integrated into the electronic document code. For example, the series of signing steps involved formulating an Electronic Will—Self-Approving, form the general basis for an AI rational agent legal assistant to fill out and execute the will, and many other court documents of title in prevention of the product of forgery or perjury; wherein the value of the human-AI user interface network invention is measured in terms of its holographic data compression execution of fewer steps being the measure of human-AI machine learning in line with human-AI rational agent alignment.
